(19) United States
(12) Patent Application Publication
(10) Pub. No.: US 2011/0117990 A1
(43) Pub. Date: May 19, 2011

(54) RAPID BONUS FEATURES USING OVERLAID SYMBOLS

(76) Inventors: Kevan L. Wilkins, Las Vegas, NV (US); Anthony J. Baerlocher, Reno, NV (US); Daniel J. DeWaal, Las Vegas, NV (US); Alexander Popovich, Henderson, NV (US)

(21) Appl. No.: 12/618,434

(22) Filed: Nov. 13, 2009

(51) Int. Cl. A63F 9/24; A63F 13/00

(52) U.S. Cl. 463/20; 463/30; 463/42

(57) ABSTRACT

A gaming machine includes an electronic display device and a controller coupled to the display device. The controller is configured to present a base game via the display device, wherein the base game includes a plurality of base game symbols, and to transmit display coordinates of at least a portion of the plurality of base game symbols to a bonus controller via a network. The display device is configured to display, under control of the bonus controller, an overlay image including at least one bonus symbol having substantially similar display coordinates as at least one of the at least a portion of the plurality of base game symbols.

### BACKGROUND

The embodiments described herein relate generally to gaming systems that provide bonus games and, more particularly, to methods and systems for providing rapid bonus awards using overlaid symbols.

At least some known gaming systems use master game play and player tracking elements in an attempt to optimize and enhance use of an electronic gaming machine main gaming screen. Moreover, at least some gaming systems use a controller that is coupled to a bank of gaming machines for use in providing mystery bonuses, celebration messages, and/or award credits during game play. However, known controllers generally require interruptions of play of the base games. For example, some of such known controllers provide an interruption, such as a mystery bonus, during play of a base game, wherein the mystery bonus has no feature in common with the base game. Such systems add little to player experience in that they do not build additional player anticipation or expectation.

### BRIEF DESCRIPTION

In one aspect, a gaming machine is provided, including an electronic display device and a controller coupled to the display device. The controller is configured to present a base game via the display device, wherein the base game includes a plurality of base game symbols, and to transmit display coordinates of at least a portion of the plurality of base game symbols to a bonus controller via a network. The display device is configured to display, under control of the bonus controller, an overlay image including at least one bonus symbol having substantially similar display coordinates as at least one of the at least a portion of the plurality of base game symbols.

In another aspect, a bonus controller is provided for use with a gaming network. The bonus controller includes a memory and a processor coupled to the memory. The processor is configured to receive gaming data via the gaming network during play of a base game at the gaming machine, receive display coordinates of base game symbols displayed by the gaming machine during play of the base game, and determine whether to award an award at the gaming machine based on the gaming data. Responsive to a determination to award the award, the processor is also configured to cause an electronic display device of the gaming machine to display an overlay image including at least one bonus symbol having substantially similar display coordinates as a corresponding base game symbol.

In yet another aspect, a method is provided for presenting a bonus feature during play of a base game at a gaming machine. The method includes displaying a plurality of base game symbols via an electronic display device of the gaming machine, transmitting gaming data to a bonus controller, and transmitting display coordinates of each of the plurality of base game symbols to the bonus controller. The method also includes using the display device, under control of the bonus controller, to display a plurality of bonus symbols overlaying at least a portion of the plurality of base game symbols, wherein each bonus symbol is positioned at substantially similar display coordinates as a corresponding base game symbol of the plurality of base game symbols.

In a further aspect, a gaming machine is provided that includes an input/output (I/O) circuit coupled to a bonus controller via a network, wherein the I/O circuit is configured to receive video signals from the bonus controller representative of a first set of game symbols, and receive video signals from the bonus controller representative of a second set of game symbols, wherein the second set of game symbols includes a subset of the first set of game symbols. The gaming machine also includes an electronic display device coupled to the I/O circuit, wherein the display device is configured to display at least one video image that includes the first set of game symbols, and display at least one video image that includes the second set of game symbols.

In another aspect, a bonus controller is provided for use with a plurality of gaming machines. The bonus controller includes a memory and a processor coupled to the memory, wherein the processor is configured to determine at least a portion of the plurality of gaming machines that are eligible for participating in a communal game, and control an electronic display device of each of the eligible gaming machines to display a first set of game symbols. The processor is also configured to receive a signal from each of the eligible gaming machines representative of a selected game symbol from the first set of game symbols, and control the electronic display device of each of the eligible gaming machines to display a respective second set of game symbols, wherein each respective second set of game symbols includes at least one modified game symbol associated with the modified game symbol having been selected at a different eligible gaming machine.

Still another aspect provides a method of game play that includes broadcasting, by a bonus controller to a plurality of gaming machines over a network, an initial set of game symbols, and receiving, by the bonus controller from each of the plurality of gaming machines, a player selection of a game symbol of the initial set of game symbols. The method also includes broadcasting, by the bonus controller, an updated set of game symbols, wherein the updated set of game symbols displayed by a first gaming machine of the plurality of gaming machines reflects a first player selection made at the first gaming machine and a second player selection made at a second gaming machine of the plurality of gaming machines.

In yet another aspect, a gaming system is provided, including at least one gaming machine having an electronic display device, and a bonus controller coupled to the gaming machine via a network. The bonus controller is configured to receive gaming data via the network during play of a base game at the gaming machine, receive display coordinates of base game symbols displayed by the display device during play of the base game, and compare the gaming data to a trigger value to determine whether to award an award at the gaming machine. The bonus controller is also configured to assume control of the display device responsive to a determination to award the award, and cause the display device to display at least one bonus symbol having substantially similar display coordinates as a corresponding base game symbol.

### BRIEF DESCRIPTION OF THE DRAWINGS

The embodiments described herein may be better understood by referring to the following description in conjunction with the accompanying drawings.

FIG. 1 is a schematic diagram of an exemplary gaming machine;

FIG. 2 is a block circuit diagram of an exemplary electrical architecture that may be used with the gaming machine shown in FIG. 1;

FIG. 3 is a block schematic diagram of an exemplary gaming system;

FIG. 4 is a schematic block diagram of an exemplary electrical architecture of a bonus controller that may be used with the gaming system shown in FIG. 3;

FIG. 5 is a first screen view of an exemplary bonus feature that may be used with the gaming machine shown in FIG. 1;

FIG. 6 is a second screen view of the bonus feature shown in FIG. 5;

FIG. 7 is a third screen view of the bonus feature shown in FIG. 5;

FIG. 8 is a flowchart illustrating an exemplary method of presenting the bonus feature shown in FIGS. 5-7;

FIG. 9 is a schematic diagram illustrating a plurality of trigger values associated with respective award values;

FIG. 10 is a schematic block diagram illustrating a number of bonus symbols to be displayed based on a proximity to a trigger value;

FIG. 11 is a schematic block diagram of an exemplary system for providing a communal game;

FIG. 12 is a schematic block diagram of an exemplary payout mechanism that may be used with the communal game shown in FIG. 11;

FIG. 13 is a schematic block diagram of another exemplary payout mechanism that may be used with the communal game shown in FIG. 11; and

FIG. 14 is a flowchart illustrating an exemplary method of playing the communal game shown in FIG. 11.

### DETAILED DESCRIPTION

The embodiments described herein relate generally to gaming machines and, more particularly, to intelligently combining base game play with a bonus feature and/or communal game using a bonus controller that provides base-to-bonus integration.

The systems, methods, and apparatus described herein facilitate analyzing game states, such as current bet sizes, win amounts, and/or lines played, for use in managing player interactivity with a gaming machine via a bonus controller. Such a bonus controller provides onscreen integration of a mystery bonus award without requiring modifications to the base game. Removing the need to modify the base game to provide a mystery bonus award facilitates more rapid development and deployment of bonus features. Moreover, removing the need to modify the base game enables a communal game to be added to the base game in a more rapid and seamless manner.

Exemplary technical effects of the systems, methods, and apparatus described herein include at least one of: (a) receiving gaming data, by a bonus controller, during play of a base game at a gaming machine; (b) receiving display coordinates of base game symbols, by the bonus controller, during play of the base game; (c) determining whether to award an award at the gaming machine based on the gaming data; and (d) using the bonus controller to cause an electronic display device of the gaming machine to display one or more bonus symbols having identical display coordinates as corresponding base game symbols. Moreover, exemplary technical effects of the systems, methods, and apparatus described herein include at least one of: (e) using the bonus controller to cause an electronic display device of each of a plurality of gaming machines to display an initial set of game symbols; (f) receiving, by the bonus controller, a selection from each gaming machine of a game symbol within the initial set; (g) using the bonus controller to cause the electronic display device of each gaming machine to display an updated set of game symbols that reflects a game symbol selected by a player at a first gaming machine and a game symbol selected by a player at a second gaming machine; (h) comparing the selected game symbols; and (i) using the bonus controller to cause the electronic display device of each gaming machine to display either an image representative of a winning outcome or an image representative of a non-winning outcome based on the comparison.

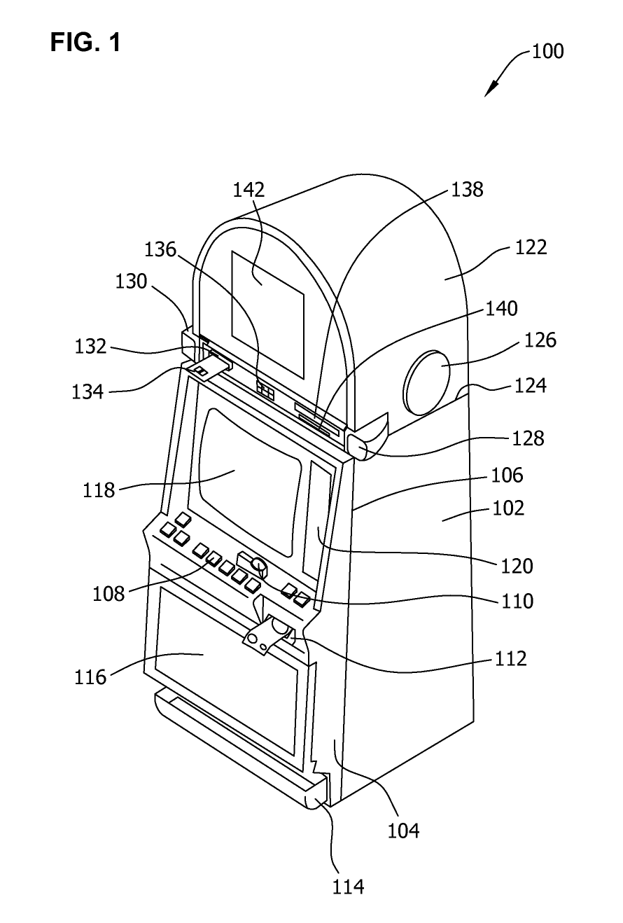

FIG. 1 is a schematic diagram of an exemplary gaming machine 100 that enables play of a base game and one or more bonus features. Gaming machine 100 may be any type of gaming machine, and may include, without limitation, different structures than those shown in FIG. 1. Moreover, gaming machine 100 may employ different methods of operation than those described below.

In the exemplary embodiment, gaming machine 100 includes a main cabinet 102 having a main door 104 coupled to a front 106 of gaming machine 100. When opened, door 104 provides access to an interior (not shown) of gaming machine 100. In the exemplary embodiment, a plurality of player-input switches and/or buttons 108 is coupled to main door 104. Moreover, in the exemplary embodiment, a coin acceptor 110, for accepting coins and/or tokens, a bill acceptor 112, for accepting and/or validating cash bills, coupons and/or ticket vouchers, a coin tray 114, for collecting a coin-based payout, and a belly glass 116 are each coupled to main door 104. A primary display device 118 and an information panel 120 are viewable through main door 104. Primary display device 118 may be implemented as a cathode ray tube (CRT), a flat-panel liquid crystal display (LCD), a plasma display, an organic light-emitting diode (OLED) display, a multi-layer display (MLD), or any other electronically-controlled video monitor. Moreover, primary display device 118 may include touch screen capabilities. In the exemplary embodiment, information panel 120 is a back-lit, silk screened glass panel that includes lettering to indicate general game information including, for example, a number of coins wagered. Coin acceptor 110, bill acceptor 112, player-input buttons 108, video display monitor 118, and information panel 120 are each used by a player to play a game on gaming machine 100. Each component 108, 110, 112, 118, and/or 120 is controlled by a gaming machine controller (not shown in FIG. 1) that is housed inside main cabinet 102. Numerous games including, but not limited to only including, video slot games, video poker, video pachinko, video black jack, video card games, and/or video keno may be implemented for play on gaming machine 100.

In the exemplary embodiment, gaming machine 100 also includes a top box 122 that is positioned on a top surface 124 of main cabinet 102. In the exemplary embodiment, top box 122 includes a number of devices that may be used to add features to a game being played on gaming machine 100. Such devices may include, but are not limited to only including, speakers 126, 128, and 130, a ticket printer 132 for printing bar-coded tickets 134, a key pad 136 for entering player tracking information, or player preferences or characteristics, a display 138 for displaying player tracking information and/or player preferences or characteristics, and a card reader 140 for receiving a card containing player tracking information and/or player preferences or characteristics encoded thereon. Card reader 140 may also be used to accept credit cards, printed cards, smart cards, and/or other magnetic stripe cards. Moreover, top box 122 includes a secondary display device 142 that displays, for example, player information, an attract sequence, a bonus game, or any other suitable images. Secondary display device 142 may be implemented as a cathode ray tube (CRT), a flat-panel liquid crystal display (LCD), a plasma display, an organic light-emitting diode (OLED) display, a multi-layer display (MLD), or any other electronically-controlled video monitor. Moreover, secondary display device 142 may include touch screen capabilities. Top box 122 may house additional devices not shown in FIG. 1, such as, for example, a bonus wheel and/or a back-lit silk screened panel that may be used to add bonus features to a game being played on gaming machine 100. During play of a base game, such devices may be controlled by circuitry, such as the gaming machine controller housed within main cabinet 102. During play of a bonus game, such devices may be controlled by circuitry, such as a bonus controller (not shown in FIG. 1) as described in detail below.

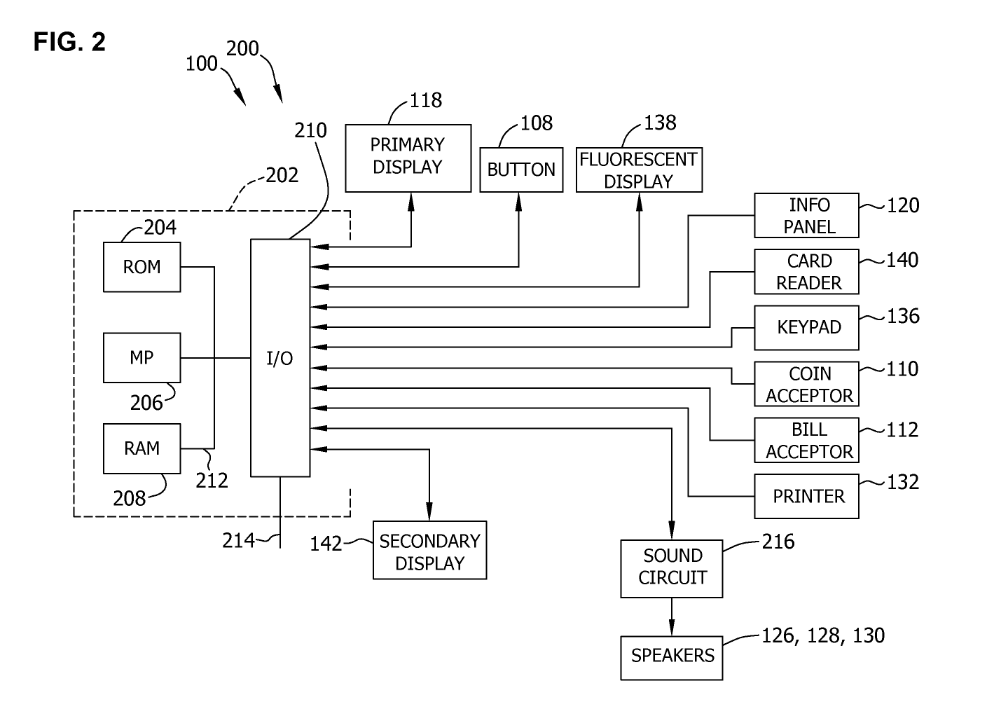

FIG. 2 is a block circuit diagram of an exemplary electrical architecture 200 incorporated into an exemplary gaming machine, such as gaming machine 100. In the exemplary embodiment, gaming machine 100 includes a gaming machine controller 202 that includes a read-only memory (ROM) 204, a microcontroller or microprocessor (MP) 206, a random-access memory (RAM) 208, and an input/output (I/O) circuit 210, each coupled via an address/data bus 212. As used herein, the terms “controller” and “processor” may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the terms “controller” or “processor”. Alternative embodiments of controller 202 may include more than one microprocessor 206, multiple RAM modules 208, and/or multiple ROM modules 204. Moreover, although I/O circuit 210 is shown in FIG. 2 as a single component, one of ordinary skill in the art will appreciate that I/O circuit 210 may include any number or a plurality of different types of I/O circuits. Further, RAM 208 and/or ROM 204 may be implemented as, for example, semiconductor memories, magnetically readable memories, and/or optically readable memories. In one embodiment, each operational component of gaming machine 100 is coupled to I/O circuit 210 via a respective conductor and/or via bus 212. Alternative embodiments may include a single coupling between the operational components of gaming machine 100 and I/O circuit 210. In the exemplary embodiment, I/O circuit 210 is coupled to a gaming network (not shown) via a network interface 214. Moreover, in the exemplary embodiment, architecture 200 includes a sound circuit 216 that generates audio signals and that communicates the audio signals between I/O circuit 210 and speakers 126, 128, and/or 130.

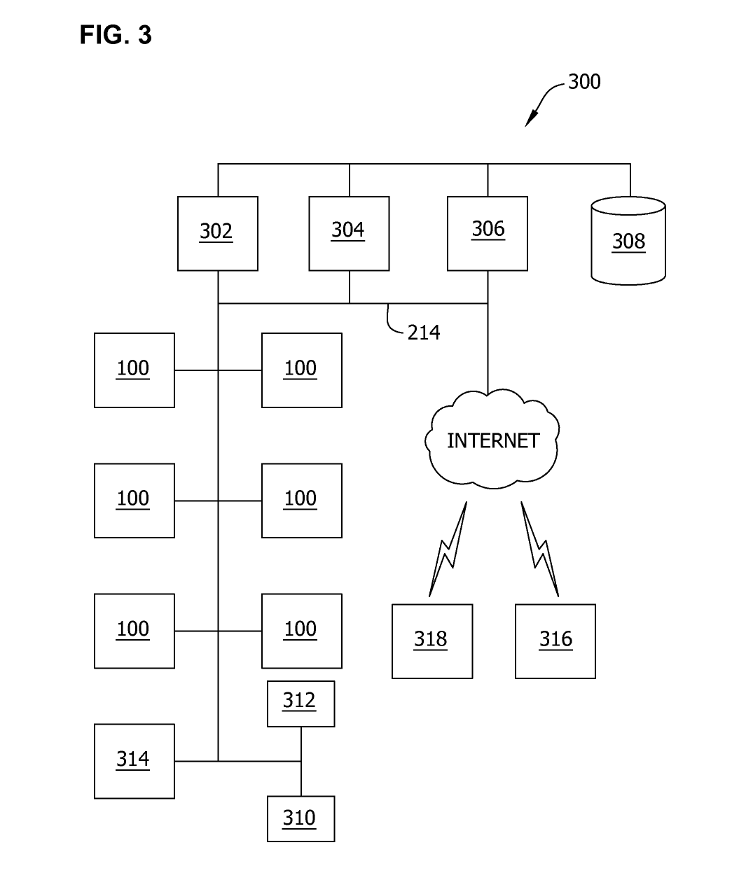

FIG. 3 is a block schematic diagram of an exemplary gaming system 300 that includes a plurality of gaming machines 100. Each gaming machine 100 is coupled via a network connection 214 to one or more controllers, such as a bonus controller 302, a game play controller 304, and a player tracking controller 306. Each controller 302, 304, and 306 includes a processor (not shown) that facilitates data communication between each gaming machine 100 and other components of gaming system 300. Such data is stored in, for example, a database 308 that is coupled to each controller 302, 304, and 306. Moreover, each controller 302, 304, and 306 also includes audio capabilities, such as a CD-ROM drive (not shown) or DVD-ROM drive (not shown), that are coupled to a sound card (not shown) for processing and transmitting digitized sound effects to one or more speakers 310 in response to commands issued over gaming system 300 by a corresponding controller 302, 304, and/or 306. Each controller 302, 304, and 306 is also coupled via gaming system 300 to an electronic sign or screen 312 that displays information, such as via scrolling and/or flashing messages that indicate, for example, progressive and/or jackpot amounts, and that are visible to players playing gaming machines 100. Messages for display on each electronic screen 312 are generated and/or modified in response to commands issued over gaming system 300 by controllers 302, 304, and/or 306.

As described above, gaming machines 100 may include video poker machines, video slot machines, and/or other similar gaming machines that implement alternative games. Moreover, gaming machines 100 may be terminal-based machines, wherein the actual games, including random number generation and/or outcome determination, are performed at a server, such game play controller 304. In such an embodiment, gaming machine 100 displays results of the game via primary display device 118 (shown in FIG. 1).

Moreover, in the exemplary embodiment, gaming system 300 includes a configuration workstation 314 that includes a user interface (not shown) that enables an administrator to set up and/or to modify portions of gaming system 300 and/or controllers 302, 304, and 306. Player tracking controller 306 tracks data of players using gaming machines 100, and also controls messages that appear on each display device 118 and 142 and/or information panel 120 of gaming machines 100. In the exemplary embodiment, player tracking controller 306 also stores physical characteristics of players, such as the player age and/or vision data. Bonus controller 302 controls bonus applications or bonus systems that award bonus opportunities on gaming system 300. Moreover, bonus controller 302 includes a set of rules for awarding jackpots in excess of those established by winning pay tables (not shown) of each gaming machine 100. Some bonus awards may be awarded randomly, while other bonus awards may be made to groups of gaming machines 100 operating in a progressive jackpot mode. Player tracking controller 306 may store data related to the players and tracked using player tracking identification, such as a player card. Moreover, player tracking controller 306 may store information and data about the player such as loyalty points, player address, phone number, and any information that may be retrieved and transmitted to the bonus controller 302. Game play controller 304 may store and track information such as, but not limited to, the average amount of wager played by the player, and/or any funds the player may have in an account.

Furthermore, in the exemplary embodiment, gaming system 300 includes one or more remote computers 316 and/or mobile devices 318 that access system 300 via an external network, such as the Internet.

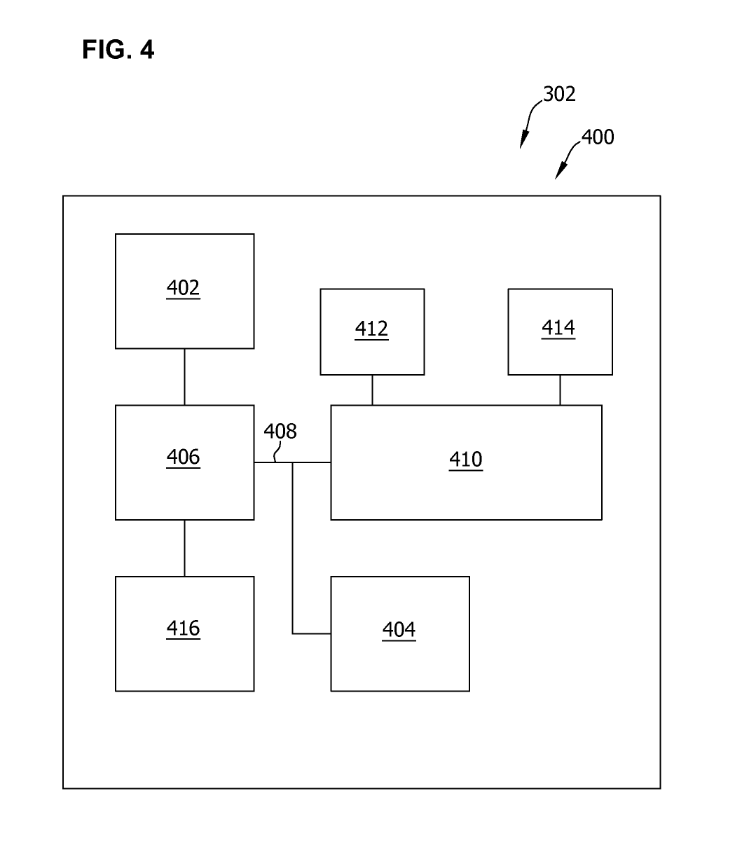

FIG. 4 is a schematic block diagram of an exemplary electrical architecture 400 of bonus controller 302. In the exemplary embodiment, bonus controller 302 includes a network interface 402 that facilitates communication between controller 302 and gaming system 300 (shown in FIG. 3). Interface 402 is not intended to be limiting, as any combination of hardware and software may be used that enables the various input/output devices to communicate with bonus controller 302. Moreover, in the exemplary embodiment, bonus controller 302 includes one or more memory modules 404, such as a read-only memory (ROM) and/or a random-access memory (RAM). Memory 404 is coupled to a microcontroller or central processor unit (CPU) 406 via an address/data bus 408. As used herein, the terms “controller” and “processor” may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the terms “controller” or “processor”. Alternative embodiments of architecture 400 may include more than one processor 406 and/or multiple memory modules 404. Moreover, memory 404 may be implemented as, for example, semiconductor memory, magnetically readable memory, and/or optically readable memory.

In some embodiments, bonus controller 302 also includes a configuration manager 410 that enables a user to setup, configure, and/or modify various bonus awards 412 that are offered and qualifying criteria 414 that must be satisfied before awards 412 are offered to the player. For example, qualifying criteria 414 may be any gaming data such as a wager amount, a wager denomination, a win amount, a player level, play duration, a number of lines played, or any other desired qualifying criteria. Configuration manager 410 may be used in cooperation with configuration workstation 314 (shown in FIG. 3). In some embodiments, a casino may have separate systems for player tracking, accounting, cage and credit system, and the like. Thus, to enable the various token awards to be offered, bonus controller 302 communicates and obtains information from each of the various systems. For example, bonus controller 302 may receive gaming data from any one or more of gaming machine 100 (shown in FIG. 1), game play controller 304 (shown in FIG. 3), and player tracking controller 306 (shown in FIG. 3) to determine the player's eligibility to participate in a bonus feature or communal gaming feature, as described in more detail below.

In the exemplary embodiment, bonus controller 302 also includes an overlay communicator 416 that is coupled to processor 406. Overlay communicator 416 selectively assumes control of primary display device 118 (shown in FIG. 1) to facilitate presenting a bonus game or bonus feature to a player. Overlay communicator 416 also receives display coordinates of each base game symbol displayed via primary display device 118 during play of a base game. The display coordinates are stored in memory 404 and are associated with an identifier for each gaming machine 100. As described in more detail below, during a bonus feature, overlay communicator 416 cause primary display device 118 to display bonus symbols using identical or substantially similar display coordinates as corresponding base game symbols.

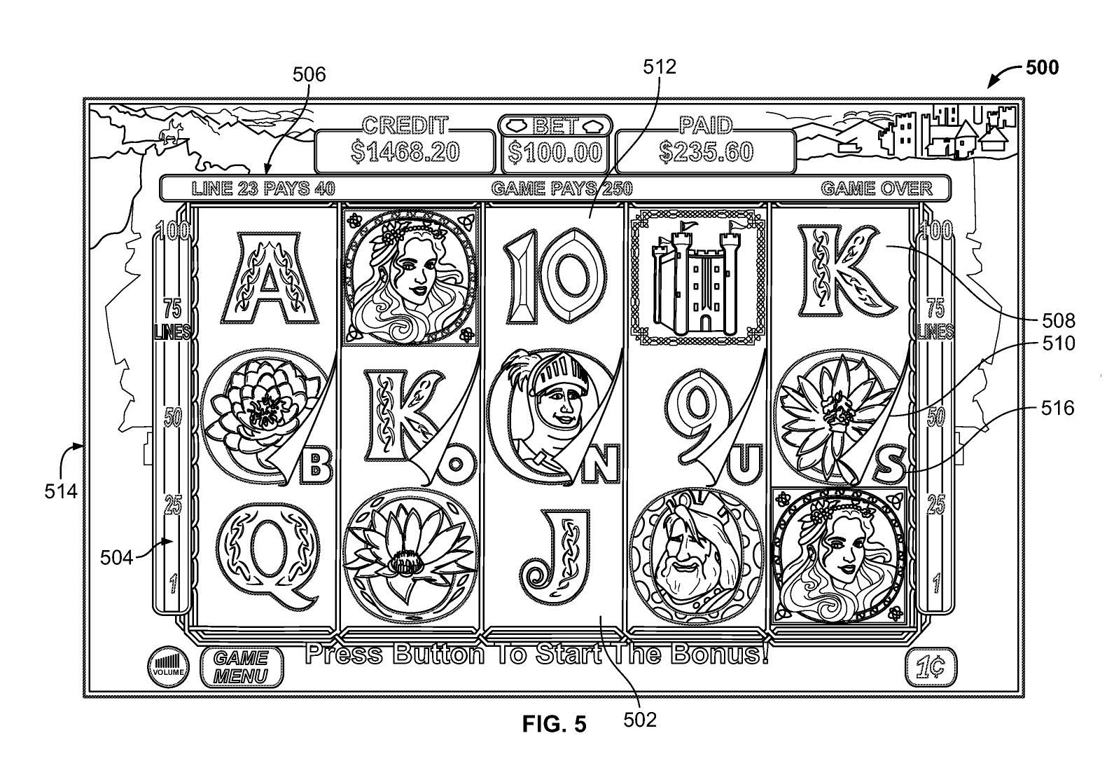

FIGS. 5-7 are screen views of an exemplary bonus feature 500 as displayed by gaming machine 100 (shown in FIGS. 1 and 2) and, more specifically, by primary display device 118 (shown in FIGS. 1 and 2) under control of bonus controller 302 (shown in FIGS. 3 and 4). In the exemplary embodiment, bonus feature 500 includes a plurality of symbols 502 arranged in a plurality of rows 504 and in a plurality of columns 506. Symbols 502 include base game symbols 508 that are displayed to a player during play of a base game, and bonus symbols 510 that are displayed to the player in response to bonus controller 302 determining that the player has earned an award.

During play of the base game, a player selects one or more paylines (not shown) and initiates the base game using, for example, buttons 108 (shown in FIGS. 1 and 2) or via touch contact on primary display device 118. Each payline includes a plurality of specific symbol locations 512 arranged across columns 506. In the exemplary embodiment, each column 506 is depicted using video images on primary display device 118. In an alternative embodiment, each column 506 is produced on a separate reel device (not shown) that is positioned adjacent to an inner surface (not shown) of primary display device 118. In the exemplary embodiment, bonus feature 500 is initiated based on an analysis by bonus controller 302 of gaming data received from each gaming machine 100. In an alternative embodiment, bonus feature 500 is initiated when a predetermined number of bonus trigger symbols (not shown) are displayed as an outcome of the base game.

In the exemplary embodiment, and during bonus feature 500, overlay communicator 416 causes primary display device 118 to display an overlay image 514, wherein selected bonus symbols 510 appear to “peel back” after being spun, thereby creating a second level of anticipation in the player. As shown in FIG. 5, when bonus controller 302 detects a win during bonus feature 500, overlay communicator 416 causes primary display device 118 to display an indicator 516 or series of indicators 516, such as the word “BONUS” via peeled back bonus symbols 510. Each bonus symbol 510 is displayed using the same display coordinates as a corresponding base game symbol 508. In an alternative embodiment, each bonus symbol 510 is displayed with an offset that is calculated based on the display coordinates of a corresponding base game symbol 508.

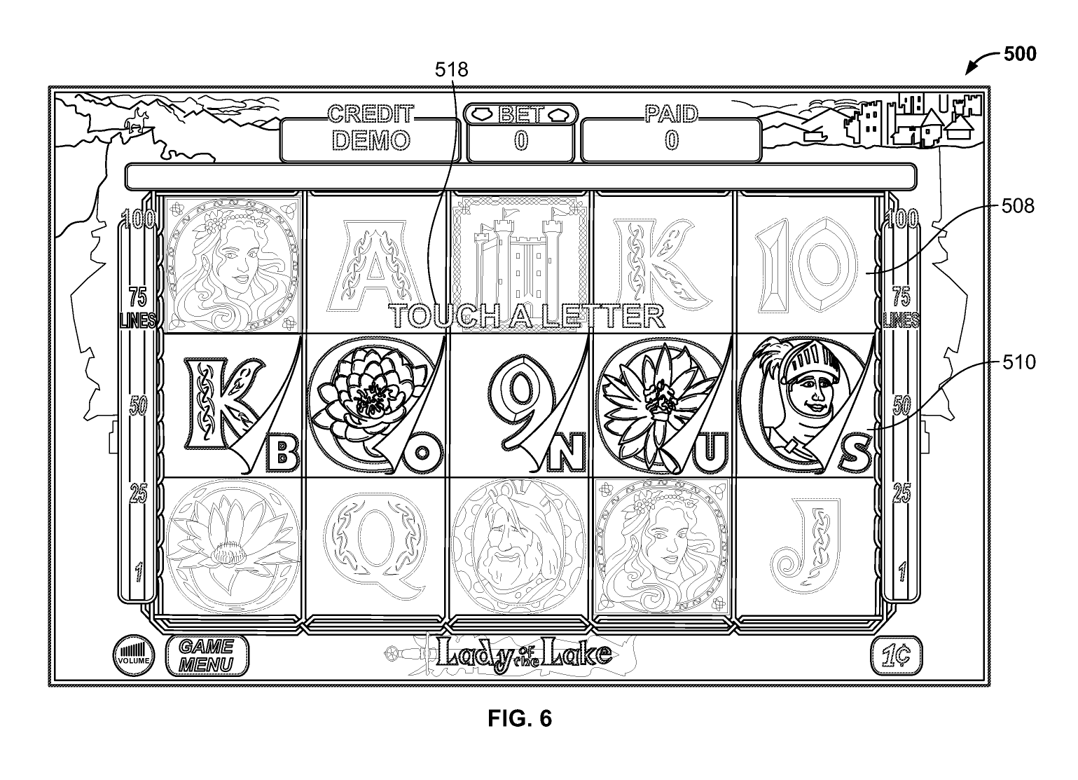

As shown in FIG. 6, overlay communicator 416 also causes primary display device 118 to display a prompt image 518 to the player. In the exemplary embodiment, overlay communicator 416 also disables each symbol 508 except for bonus symbols 510. The player may select one of bonus symbols 510 via primary display device 118 or via one of buttons 108 (shown in FIGS. 1 and 2). In some embodiments, buttons 108 are OLED buttons that are capable of displaying multiple images. In such embodiments, bonus controller 302 causes buttons 108 to display the same images as bonus symbols 510.

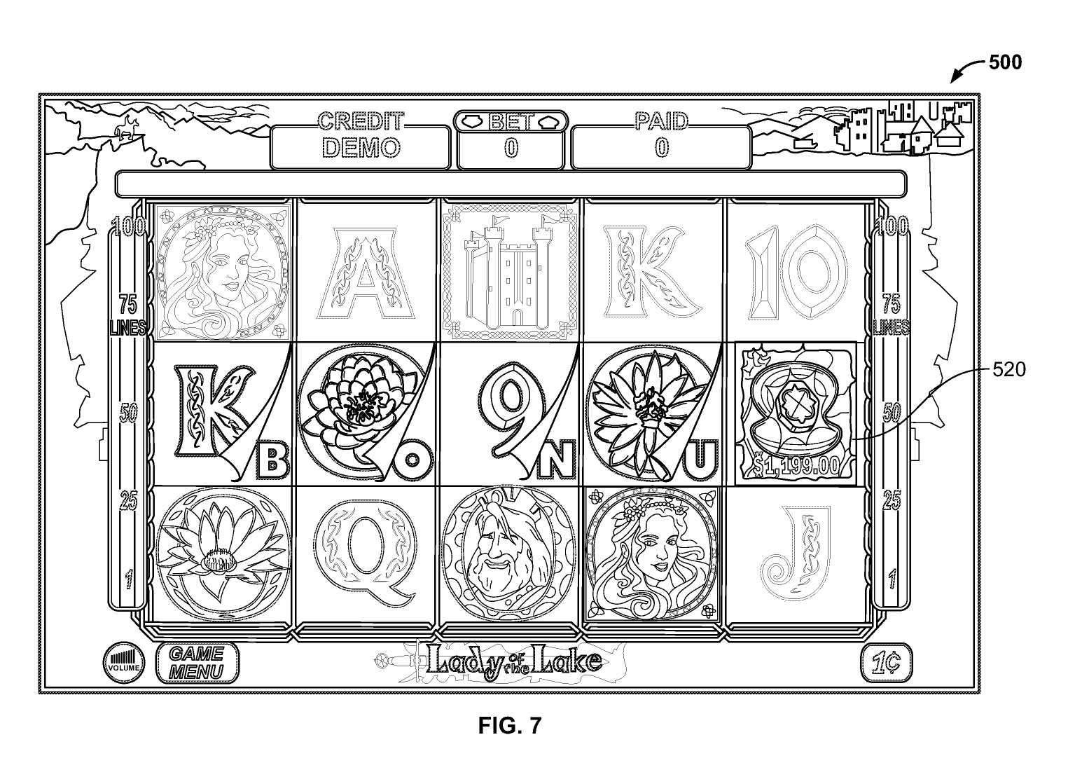

In the exemplary embodiment, and as shown in FIG. 7, once the player has selected bonus symbol 510, overlay communicator 416 causes primary display device 118 to display an award symbol 520. Award symbol 520 is displayed using the same display coordinates as a corresponding base game symbol 508. In an alternative embodiment, award symbol 520 is displayed with an offset that is calculated based on the display coordinates of a corresponding base game symbol 508.

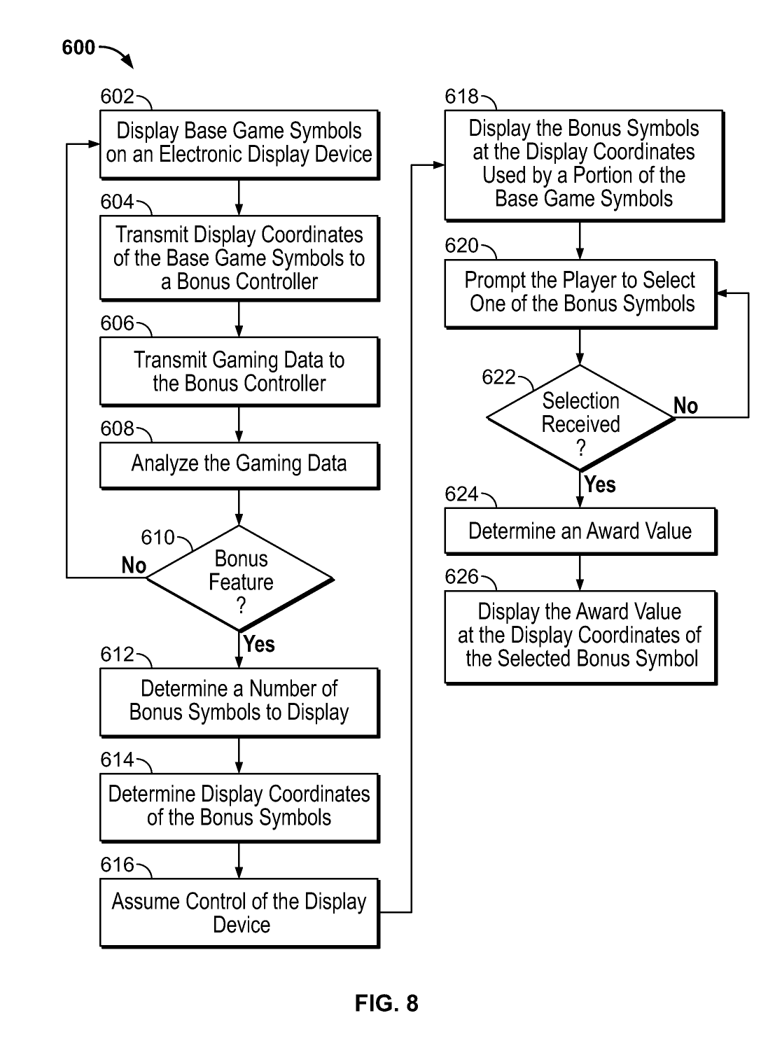

FIG. 8 is a flowchart illustrating an exemplary method 600 of presenting a bonus feature, such as bonus feature 500 (shown in FIGS. 5-7) during play of a base game at a gaming machine, such as gaming machine 100 (shown in FIGS. 1 and 2).

In the exemplary embodiment, gaming machine 100 displays 602 a plurality of base game symbols during play of a base game. In some embodiments, gaming machine 100 transmits 604 display coordinates of each base game symbol to bonus controller 302 (shown in FIGS. 3 and 4). Moreover, in some embodiments, gaming machine 100 transmits 606 gaming data to bonus controller 302. In an alternative embodiment, gaming machine 100 functions as a terminal, such that base game outcomes, and the like, are determined by game play controller 304 (shown in FIG. 3). In such an embodiment, game play controller 304 transmits 604 display coordinates to bonus controller 302, and transmits 606 gaming data to bonus controller 302. The gaming data may be, for example and not by way of limitation, a current bet size, a win amount, and/or a number of lines played during the base game. Regardless of the origination of the gaming data and display coordinates, bonus controller 302 stores the gaming data and display coordinates in memory 404 (shown in FIG. 4). More specifically, bonus controller 302 detects a gaming machine identifier associated with gaming machine 100, and stores the gaming data and display coordinates in memory 404 based on the gaming machine identifier.

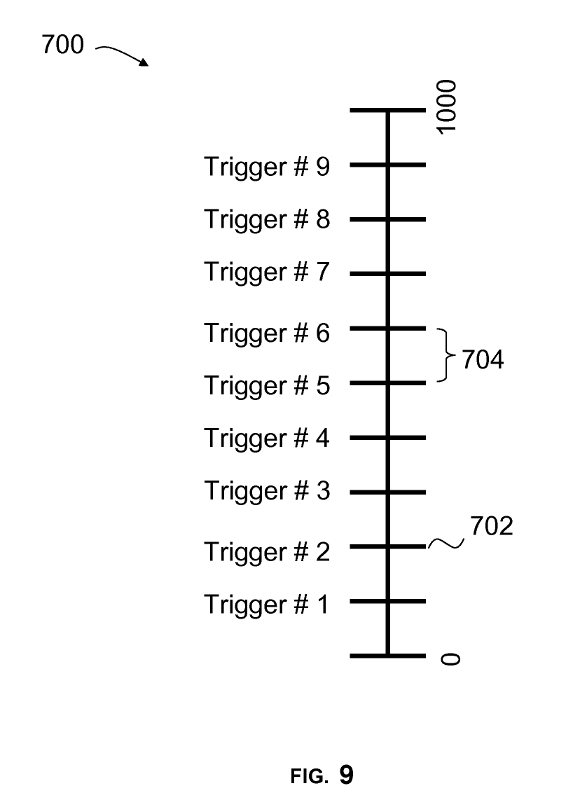

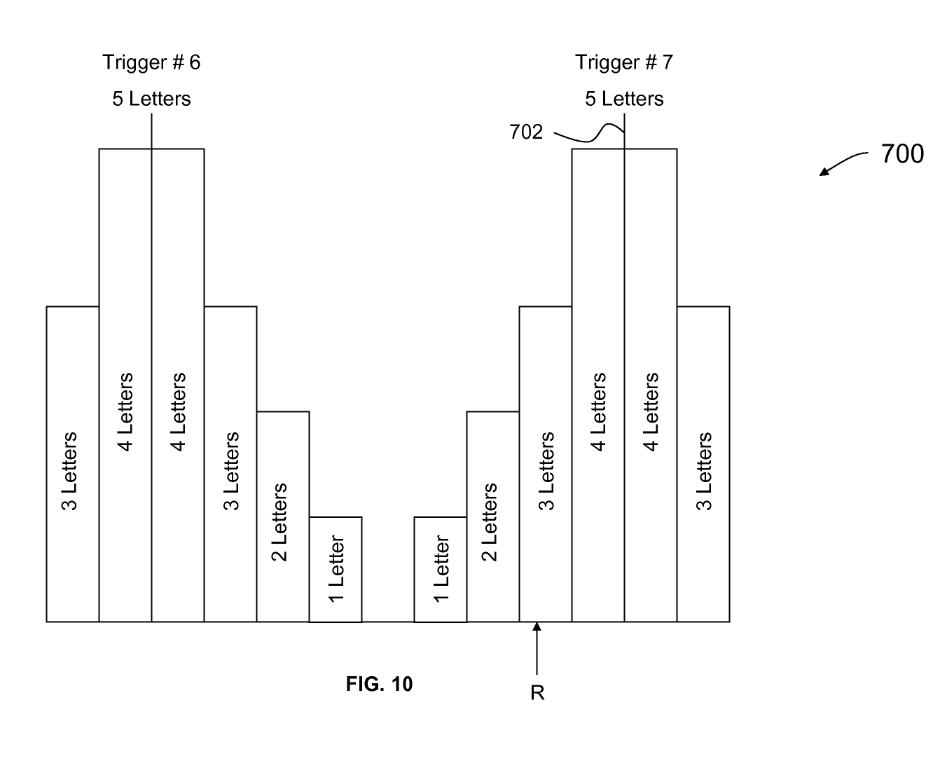

In the exemplary embodiment, bonus controller 302 analyzes 608 the gaming data, and determines 610 whether a bonus feature 500 has been earned. If a bonus feature 500 has not been earned, gaming machine 100 returns to display 602 base game symbols as part of the base game. In the exemplary embodiment, to determine whether bonus feature 500 has been earned, bonus controller 302 determines a trigger value for each of a plurality of possible award values as shown in FIG. 9. More specifically, FIG. 9 shows a range 900 of trigger values 702 with a specified value difference 704 between each trigger value 702. Each value difference 704 may be substantially similar in size, such as evenly sized, or may be differently sized. For example, as an award associated with each trigger value 702 increases in value, value difference 704 between adjacent trigger values 702 may increase. Bonus controller 302 may determine the trigger values using a random number generator or by evenly spacing the trigger values over a predetermined of slots. Such trigger values may be bet sizes, win amounts, or a number of lines played during the base game. Bonus controller 302 then compares each trigger value to the gaming data stored in memory 404 that corresponds with the gaming machine identifier of gaming machine 100. Based on the comparisons, bonus controller 302 determines 612 a number of bonus symbols 510 to display via primary display device 118. For example, and as shown in FIG. 10, if a trigger value 702 matches a randomly generated number R and/or the stored gaming data, bonus controller 302 determines that five bonus symbols 510 should be displayed to spell “BONUS” within bonus feature 500. Alternatively, bonus controller 302 may determine that fewer than five bonus symbols 510 should be displayed based on a difference between the nearest trigger value 702 and the stored gaming data. The number of bonus symbols 510 to be displayed may include, for example, four bonus symbols 510 to spell “BONU” within bonus feature 500 if the nearest trigger value 702 and the stored gaming data are separated by a single slot. Alternatively, the number of bonus symbols 510 to be displayed may include only three bonus symbols 510 to spell “BON” within bonus feature 500 if the nearest trigger value 702 and the stored gaming data are separated by two slots.

In an alternative embodiment, to determine whether a bonus feature 500 has been earned, bonus controller 302 generates a random gaming data value. For example, bonus controller 302 may generate a random bet size, a random win amount, or a random number of lines played during the base game. Bonus controller 302 then compares the random gaming data value to the gaming data stored in memory 404 that corresponds with the gaming machine identifier of gaming machine 100. If the random gaming data value and the stored gaming data match, bonus controller 302 determines 612 a number of bonus symbols 510 (shown in FIG. 5) to display via primary display device 118 (shown in FIGS. 1 and 2). For example, if the random gaming data value and the stored gaming data match, bonus controller 302 determines that five bonus symbols 510 should be displayed to spell “BONUS” within bonus feature 500. Alternatively, if the random gaming data value and the stored gaming data do not match, bonus controller 302 determines that fewer than five bonus symbols 510 should be displayed. The number of bonus symbols 510 to be displayed may be randomly determined to include, for example, four bonus symbols 510 to spell “BONU” within bonus feature 500.

In the exemplary embodiment, bonus controller 302 presents bonus feature 500. More specifically, bonus controller 302 determines 614 display coordinates for each of the bonus symbols 510 to be displayed via primary display device 118. For example, bonus controller 302 reads display coordinates of three base game symbols and uses the same display coordinates to display three bonus symbols 510. When an award is to be awarded, bonus controller 302 reads display coordinates of five base game symbols and uses the same display coordinates to display five bonus symbols 510, as shown in FIG. 5. Bonus controller 302 then assumes 616 control of primary display device 118 and causes primary display device 118 to display 618 an overlay that includes the appropriate number of bonus symbols 510 using the display coordinates of the corresponding base game symbols.

In the exemplary embodiment, bonus controller 302 prompts 620 the player playing at gaming machine 100 to select one of the displayed bonus symbols 510. In the exemplary embodiment, primary display device 118 includes a touch screen. Bonus controller 302 polls, such as periodically, primary display device 118 and/or I/O circuit 210 to determine 622 whether a selection has been received. In an alternative embodiment, bonus controller 302 assumes control of primary display device 118 and buttons 108. In such an embodiment, bonus controller 302 displays the appropriate number of bonus symbols 510 using buttons 108, as well as primary display device 118. Moreover, in such an embodiment, bonus controller 302 polls buttons 108 and/or I/O circuit 210 to determine 622 whether a selection has been received.

In the exemplary embodiment, and after the selection has been received, bonus controller 302 determines 624 an award value. Moreover, bonus controller 302 displays 626 via primary display 118 an image that includes the award value using the display coordinates of the selected bonus symbol 510. In one embodiment, bonus controller 302 determines the award value prior to receiving the selection, and displays the award value image using the display coordinates of the selected bonus symbol 510 regardless of the bonus symbol 510 selected. In another embodiment, bonus controller 302 determines the award value based on the selected bonus symbol 510.

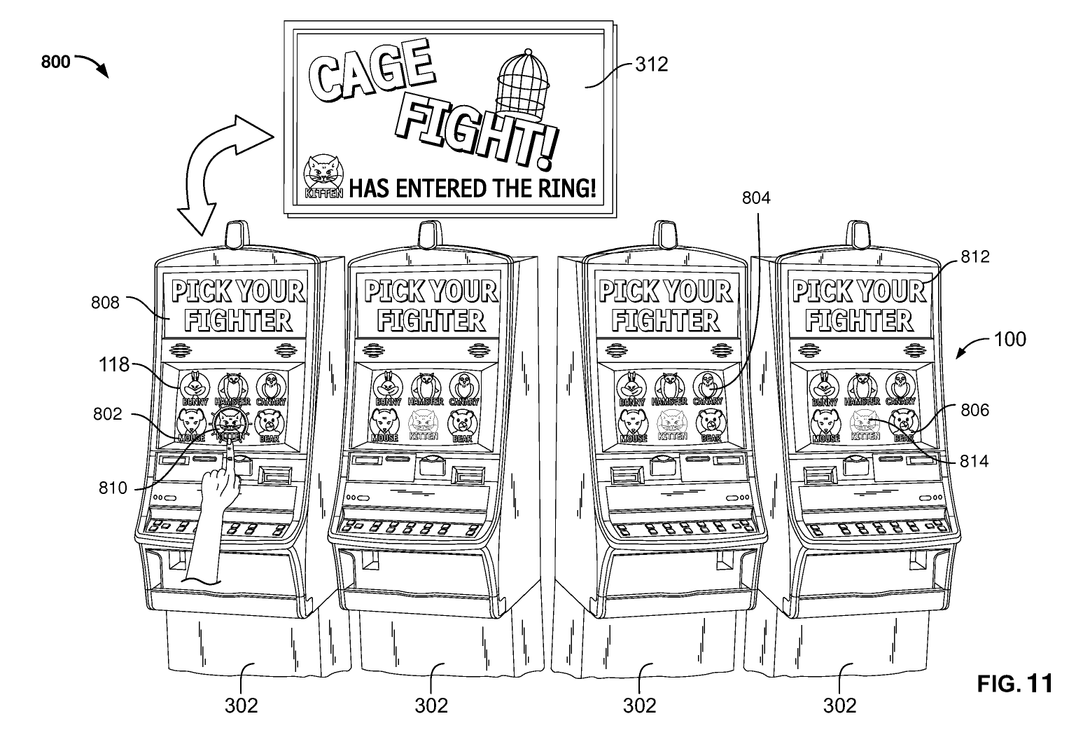

FIGS. 11-13 are diagrams illustrating an exemplary communal game 800 presented to players of a plurality of gaming machines 100. As shown in each of FIGS. 11-13, each gaming machine 100 is coupled to bonus controller 302 via gaming network 214. As shown in FIG. 11, bonus controller 302 causes the primary display device 118 of each gaming machine 100 to display an initial set 802 of game symbols 804. In the exemplary embodiment, initial set 802 is identical for each gaming machine 100. In an alternative embodiment, initial set 802 differs from one gaming machine 100 to another. In the exemplary embodiment, a player of each gaming machine 100 selects a respective game symbol 804. Bonus controller 302 causes primary display device 118 of each gaming machine 100 to display an updated set 806 of game symbols 804. As displayed by a first gaming machine 808, updated set 806 includes a first modified game symbol 810 that illustrates the selected game symbol 804 by the player at first gaming machine 808. Moreover, as displayed by a second gaming machine 812, updated set 806 includes a second modified game symbol 814 that illustrates the selected game symbol 804 by the player at first gaming machine 808. As such, bonus controller 302 automatically updates each primary display device 118 by, for example, broadcasting and controlling each primary display device 118 to display updated set 806 of game symbols 804.

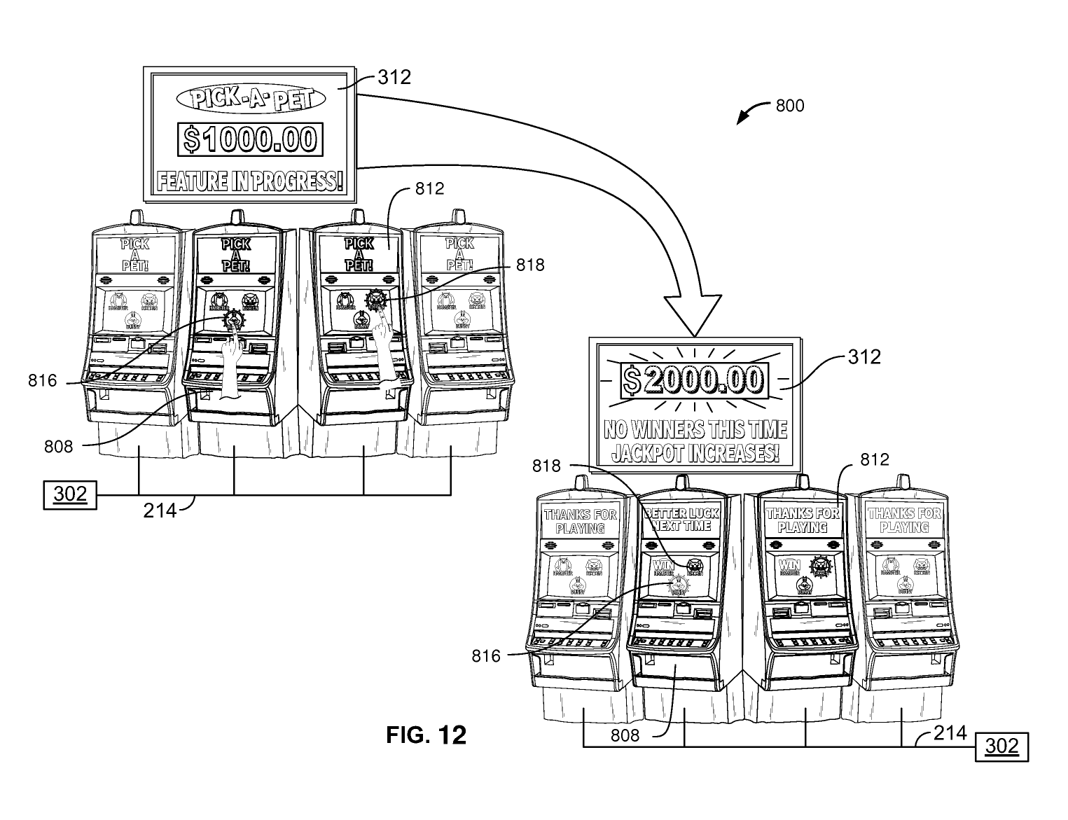

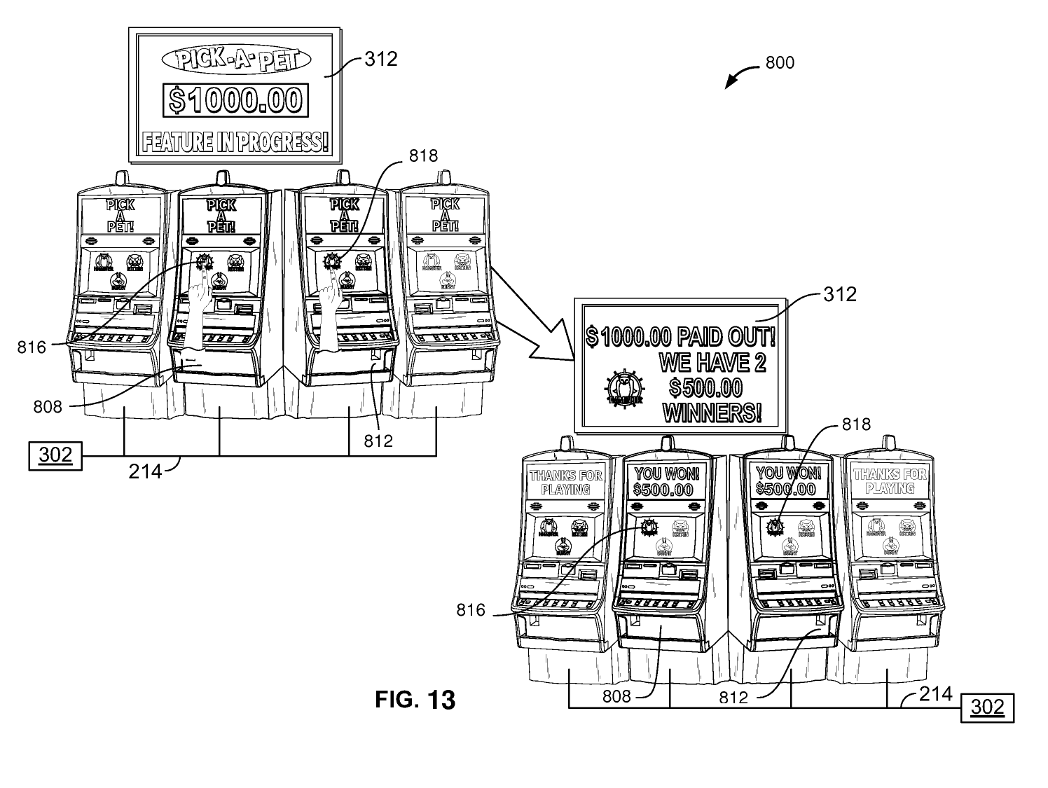

FIGS. 12 and 13 each illustrate a payout mechanism for use with communal game 800. As shown in FIGS. 12 and 13, only a portion of gaming machines 100 may be eligible for participation in communal game 800. Bonus controller 302 determines eligibility and causes primary display device 118 of each eligible gaming machine 100 to display initial set 802 of game symbols 804. A player playing at each gaming machine 100 selects a respective game symbol 816 and 818, and bonus controller 302 compares the selections. As shown in FIG. 12, when bonus controller 302 determines that the selected game symbols 816 and 818 are different, bonus controller 302 causes primary display device 118 to display an updated set 806 of game symbols 804, wherein each updated set 806 is different according to the respective player selections. Moreover, bonus controller 302 causes electronic screen 312 to display a message related to the outcome. In some embodiments, any award value that was available for a winning outcome is applied by bonus controller 302 to another communal game 800.

As shown in FIG. 13, when bonus controller 302 determines that the selected game symbols 816 and 818 are identical, bonus controller 302 causes primary display device to display an updated set 806 of game symbols 804, wherein each updated set 806 is identical based on the same player selections. Moreover, bonus controller 302 causes electronic screen 312 to display a message related to the outcome. In some embodiments, any award value that was available for a winning outcome is divided by the number of players participating in communal game 800.

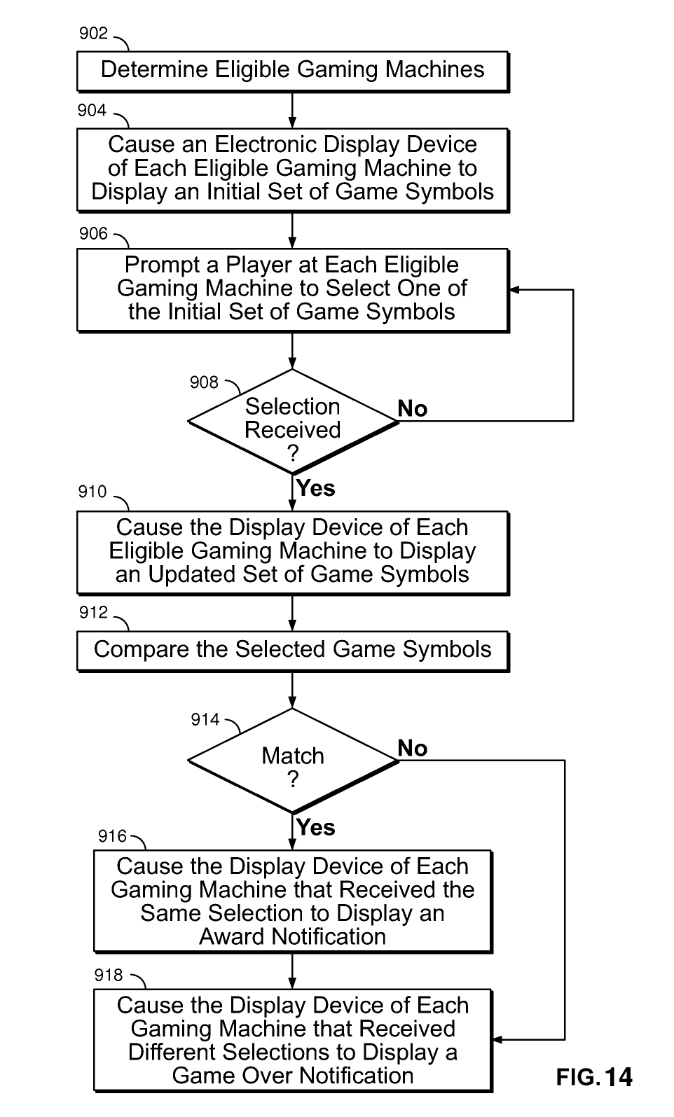

FIG. 14 is a flowchart illustrating an exemplary method 900 of playing a game, such as communal game 800 (shown in FIGS. 11-13), at a gaming machine, such as gaming machine 100 (shown in FIGS. 1 and 2).

In the exemplary embodiment, bonus controller 302 (shown in FIGS. 3 and 4) determines 902 a number of eligible gaming machines 100 for inclusion in communal game 800. Eligibility may be based on gaming data transmitted by each gaming machine 100 to bonus controller 302, such as, but not limited to, wager amounts, win amounts, and/or a number of paylines played. After determining a number of eligible gaming machines 100, bonus controller 302 causes primary display device 118 (shown in FIGS. 1 and 2) of each gaming machine 100 to display 904 initial set 802 (shown in FIG. 11) of game symbols 804 (shown in FIG. 11). In the exemplary embodiment, initial set 802 is identical for each gaming machine 100. In an alternative embodiment, initial set 802 differs from one gaming machine 100 to another.

In the exemplary embodiment, bonus controller 302 causes primary display device 118 to display 906 a prompt to respective players of each eligible gaming machine 100 to select a desired game symbol 804. Moreover, in the exemplary embodiment, primary display device 118 includes a touch screen. Bonus controller 302 polls, such as periodically poll, primary display device 118 and/or I/O circuit 210 to determine 908 whether a selection has been received. In an alternative embodiment, bonus controller 302 assumes control of primary display device 118 and buttons 108. In such an embodiment, bonus controller 302 displays the appropriate number of bonus symbols 510 using buttons 108 as well as primary display device 118. Moreover, in such an embodiment, bonus controller 302 polls buttons 108 and/or I/O circuit 210 to determine 908 whether a selection has been received.

When bonus controller 302 determines that a selection has been received from each eligible gaming machine 100, bonus controller 302 causes primary display device 118 of each gaming machine 100 to display 910 updated set 806 (shown in FIG. 11) of game symbols 804. As displayed by first gaming machine 808 (shown in FIG. 11), updated set 806 includes first modified game symbol 810 (shown in FIG. 11) that illustrates the selected game symbol 804 by the player at first gaming machine 808. Moreover, as displayed by second gaming machine 812 (shown in FIG. 11), updated set 806 includes second modified game symbol 814 (shown in FIG. 11) that illustrates the selected game symbol 804 by the player at first gaming machine 808.

In the exemplary embodiment, bonus controller 302 compares 912 the selected game symbols 816 and 818 (shown in FIG. 12). When bonus controller 302 determines 914 that the selected game symbols 816 and 818 are identical, bonus controller 302 causes primary display device to display updated set 806 of game symbols 804, wherein each updated set 806 is identical based on the same player selections. Moreover, for each gaming machine 100 that received the same selected game symbols 816 and 818, bonus controller 302 causes 916 primary display device 118 to display an award notification. In addition, for each gaming machine 100 that received different selected game symbols 816 and 818, bonus controller 302 causes 918 primary display device 118 to display a game over notification.

When bonus controller 302 determines 914 that the selected game symbols 816 and 818 are different, bonus controller 302 causes primary display device 118 of each gaming machine 100 to display updated set 806 of game symbols 804, wherein each updated set 806 is different according to the respective player selections. Moreover, for each gaming machine 100 that received different selected game symbols 816 and 818, bonus controller 302 causes 918 primary display device 118 to display a game over notification.

In some embodiments, the term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

Although the present invention is described in connection with an exemplary gaming system environment, embodiments of the invention are operational with numerous other general purpose or special purpose gaming system environments or configurations. The gaming system environment is not intended to suggest any limitation as to the scope of use or functionality of any aspect of the invention. Moreover, the gaming system environment should not be interpreted as having any dependency or requirement relating to any one or combination of components illustrated in the exemplary operating environment. Examples of well known gaming systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Exemplary embodiments of apparatus, systems, methods, and computer-readable storage media for awarding dynamically valued tokens during game play are described above in detail. The apparatus, systems, methods, and storage media are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

Moreover, the order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A gaming machine comprising:
an electronic display device; and
a controller coupled to said display device, said controller configured to:
present a base game via said display device, wherein the base game includes a plurality of base game symbols; and
transmit display coordinates of at least a portion of the plurality of base game symbols to a bonus controller via a network, wherein said display device is configured to display, under control of the bonus controller, an overlay image including at least one bonus symbol having substantially similar display coordinates as at least one of the at least a portion of the plurality of base game symbols.

2. A gaming machine in accordance with claim 1, wherein said controller is further configured to transmit gaming data via the network to the bonus controller.

3. A gaming machine in accordance with claim 1, wherein said controller is further configured to transmit the display coordinates to during play of the base game the bonus controller.

4. A gaming machine in accordance with claim 1, wherein said controller is further configured to:
receive a signal from the bonus controller related to a bonus event; and
release control of said display device to the bonus controller in response to the signal.

5. A gaming machine in accordance with claim 1, wherein the at least one bonus symbol includes a plurality of bonus symbols that each have substantially similar display coordinates as a corresponding one of the at least a portion of the plurality of base game symbols.

6. A gaming machine in accordance with claim 5, wherein said display device is further configured to prompt a player of said gaming machine to select one of the plurality of bonus symbols.

7. A gaming machine in accordance with claim 6, wherein said display device is further configured to display an award associated with the selected bonus symbol.

8. A bonus controller for use with a gaming network, said bonus controller comprising:
a memory; and
a processor coupled to said memory, said processor configured to:
receive gaming data via the gaming network during play of a base game at the gaming machine;
receive display coordinates of base game symbols displayed by the gaming machine during play of the base game;
determine whether to award an award at the gaming machine based on the gaming data; and
responsive to a determination to award the award, cause an electronic display device of the gaming machine to display an overlay image that includes at least one bonus symbol that has substantially similar display coordinates as a corresponding base game symbol.

9. A bonus controller in accordance with claim 8, wherein said processor is configured to receive at least one of the gaming data and the display coordinates from the gaming machine.

10. A bonus controller in accordance with claim 8, wherein said processor is configured to receive at least one of the gaming data and the display coordinates from a game server that controls game play on the gaming machine.

11. A bonus controller in accordance with claim 8, wherein said processor is configured to determine whether to award an award by:
generating a random gaming data value;
comparing the random gaming data value to the gaming data received via the network; and
awarding the award in response to a determination that the random gaming data value matches the received gaming data.

12. A bonus controller in accordance with claim 8, wherein the award includes a plurality of awards, said processor is configured to determine whether to award an award by:
determining a trigger value for each of the plurality of awards; and
comparing each trigger value to the gaming data received via the network.

13. A bonus controller in accordance with claim 12, wherein said processor is configured to cause the display device to display the overlay image such that the overlay image includes a number of bonus symbols each having substantially similar display coordinates as a corresponding number of the base game symbols based on a difference between the gaming data received via the network and a nearest trigger value.

14. A bonus controller in accordance with claim 8, wherein the overlay image includes a number of bonus symbols each having substantially similar display coordinates as a corresponding number of base game symbols, said processor further configured to control the display device to receive a selection by a player of one of the bonus symbols.

15. A bonus controller in accordance with claim 14, wherein said processor is further configured to determine a value of the award prior to the selection by the player.

16. A bonus controller in accordance with claim 14, wherein said processor is further configured to determine a value of the award based on the selected bonus symbol.

17. A bonus controller in accordance with claim 14, wherein said processor is further configured to cause the display device to display the value of the award at substantially similar display coordinates as the selected bonus symbol.

18. A bonus controller in accordance with claim 8, wherein the gaming machine includes at least one button, said processor further configured to alter an image displayed by the at least one button such that the at least one button displays at least one bonus symbol.

19. A method for presenting a bonus feature during play of a base game at a gaming machine, said method comprising:
displaying a plurality of base game symbols via an electronic display device of the gaming machine;
transmitting gaming data to a bonus controller;
transmitting display coordinates of each of the plurality of base game symbols to the bonus controller;
using the display device, under control of the bonus controller, to display a plurality of bonus symbols overlaying at least a portion of the plurality of base game symbols, wherein each bonus symbol is positioned at substantially similar display coordinates as a corresponding base game symbol of the plurality of base game symbols.

20. A method in accordance with claim 19, wherein using the display device to display a plurality of bonus symbols comprises displaying a random number of bonus game symbols.

21. A method in accordance with claim 19, further comprising prompting the player to select one of the plurality of bonus symbols.

22. A method in accordance with claim 21, further comprising receiving a selection of one of the plurality of bonus symbols via the display device.

23. A method in accordance with claim 21, further comprising receiving a selection of one of the plurality of bonus symbols via one of a plurality of buttons provided on a cabinet of the gaming machine.

24. A method in accordance with claim 23, further comprising using the plurality of buttons, under control of the bonus controller, to display the plurality of bonus symbols.

25. A gaming machine comprising:
an input/output (I/O) circuit coupled to a bonus controller via a network, said I/O circuit configured to:
receive video signals from the bonus controller representative of a first set of game symbols; and
receive video signals from the bonus controller representative of a second set of game symbols, wherein the second set of game symbols includes a subset of the first set of game symbols; and
an electronic display device coupled to said I/O circuit, said display device configured to:
display at least one video image that includes the first set of game symbols; and
display at least one video image that includes the second set of game symbols.

26. A gaming machine in accordance with claim 25, wherein said display device is further configured to receive a player selection of a game symbols from the first set of game symbols, and wherein said I/O circuit is further configured to transmit the selected game symbol to the bonus controller.

27. A gaming machine in accordance with claim 26, wherein the second set of game symbols includes the selected game symbol and a set of modified game symbols representative of game symbols from the first set of game symbols having been selected at other gaming machines.

28. A gaming machine in accordance with claim 26, wherein the second set of game symbols includes a modified selected game symbol.

29. A bonus controller for use with a plurality of gaming machines, said bonus controller comprising:
a memory; and
a processor coupled to said memory, wherein said processor is configured to:
determine at least a portion of the plurality of gaming machines that are eligible for participating in a communal game;
control an electronic display device of each of the eligible gaming machines to display a first set of game symbols;
receive a signal from each of the eligible gaming machines representative of a selected game symbol from the first set of game symbols; and
control the electronic display device of each of the eligible gaming machines to display a respective second set of game symbols, wherein each respective second set of game symbols includes at least one modified game symbol associated with the modified game symbol having been selected at a different eligible gaming machine.

30. A bonus controller in accordance with claim 29, wherein said processor is coupled to an external display device, said processor is further configured to cause the external display device to display each selected game symbol.

31. A bonus controller in accordance with claim 29, wherein said processor is couple to an external display device, said processor is further configured to cause the external display device to display a message indicating that the same game symbol was selected at more than one of the eligible gaming machines.

32. A bonus controller in accordance with claim 31, wherein the message indicates that the same game symbol was selected at fewer than two of the eligible gaming machines.

33. A method of game play comprising:
broadcasting, by a bonus controller to a plurality of gaming machines over a network, an initial set of game symbols;
receiving, by the bonus controller from each of the plurality of gaming machines, a player selection of a game symbol of the initial set of game symbols; and
broadcasting, by the bonus controller, an updated set of game symbols, wherein the updated set of game symbols displayed by a first gaming machine of the plurality of gaming machines reflects a first player selection made at the first gaming machine and a second player selection made at a second gaming machine of the plurality of gaming machines.

34. A method in accordance with claim 33, wherein broadcasting an initial set of game symbols comprises using an electronic display device of each of the plurality of gaming machines to display the initial set of game symbols under control of the bonus controller.

35. A method in accordance with claim 33, wherein receiving a player selection comprises receiving the player selection via a touch screen display device.

36. A method in accordance with claim 33, wherein receiving a player selection comprises receiving the player selection via one of a plurality of buttons.

37. A method in accordance with claim 33, wherein broadcasting an updated set of game symbols comprises using an electronic display device of each of the plurality of gaming machines to display the updated set of game symbols under control of the bonus controller.

38. A method in accordance with claim 33, further comprising awarding, by the bonus controller, an award to the first player and to the second player responsive to a determination that the first player selection matches the second player selection.

39. A gaming system comprising:
at least one gaming machine comprising an electronic display device; and
a bonus controller coupled to said at least one gaming machine via a network, said bonus controller configured to:
receive gaming data via said network during play of a base game at said at least one gaming machine;
receive display coordinates of base game symbols displayed by said display device during play of the base game;
compare the gaming data to a trigger value to determine whether to award an award at said at least one gaming machine;
responsive to a determination to award the award, assume control of said display device; and
cause said display device to display at least one bonus symbol having substantially similar display coordinates as a corresponding base game symbol.

40. A gaming system in accordance with claim 39, wherein said bonus controller is configured to determine whether to award an award by:
generating a random gaming data value;
comparing the random gaming data value to the gaming data received via said network; and
awarding the award in response to a determination that the random gaming data value matches the received gaming data.

41-44. (canceled)

45. A gaming system in accordance with claim 39, wherein the award includes a plurality of awards, said bonus controller is configured to determine whether to award an award by:
determining a trigger value for each of the plurality of awards; and
comparing each trigger value to the gaming data received via said network.

46. A gaming system in accordance with claim 39, wherein said bonus controller is configured to cause said display device to display a number of bonus symbols each having substantially similar display coordinates as a corresponding number of the base game symbols based on a difference between the gaming data received via said network and a nearest trigger value.

47. A gaming system in accordance with claim 39, wherein the at least one bonus symbol includes a number of bonus symbols each having substantially similar display coordinates as a corresponding number of base game symbols, said bonus controller further configured to control said display device to receive a selection by a player of one of the bonus symbols.

48. A gaming system in accordance with claim 47, wherein said bonus controller is further configured to cause said display device to display the value of the award at substantially similar display coordinates as the selected bonus symbol.

49. A gaming system in accordance with claim 39, wherein said at least one gaming machine comprises a plurality of gaming machines, said bonus controller is further configured to:
cause said display device of each of said plurality of gaming machines to display an initial set of game symbols;
receive, from each of said plurality of gaming machines, a player selection of a game symbol of the initial set of game symbols; and
cause said display device of each of said plurality of gaming machines to display an updated set of game symbols, wherein the updated set of game symbols displayed by a first gaming machine of said plurality of gaming machines reflects a first player selection made at said first gaming machine and a second player selection made at a second gaming machine of said plurality of gaming machines.
